(19) United States
(12) Patent Application Publication
(10) Pub. No.: US 2010/0250899 A1
(43) Pub. Date: Sep. 30, 2010

(54) DISTRIBUTED PROCESSING SYSTEM

(75) Inventors: Mitsunori KUBO, Tokyo (JP); Takayuki Nakatomi, Tokyo (JP); Arata Shinozaki, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/728,634

(22) Filed: Mar. 22, 2010

(30) Foreign Application Priority Data
Mar. 24, 2009 (JP) 2009-072304

(51) Int. Cl. G06F 15/76; G06F 9/06

(52) U.S. Cl. 712/30; 712/E09.003

(57) ABSTRACT

A distributed processing system includes a plurality of processing elements each having one or more inputs and one or more outputs, and a control unit to which the plurality of processing elements are connected, wherein based on a service execution request from a client, the control unit creates execution transition information in which the processing elements that are necessary to execute a specific service and an order of execution are specified.

### CROSS-REFERENCE TO RELATED APPLICATION

The present application is based upon and claims the benefit of priority from the prior Japanese Patent Application No. 2009-072304 filed on Mar. 24, 2009; the entire contents of which are incorporated herein by reference.

### BACKGROUND OF THE INVENTION

1. Field of the Invention

The present invention relates to a distributed processing system.

2. Description of the Related Art

In conventional data flow type distributed processing, a processing path for processing elements (PE) used in processing is constructed by broad cast communication or one-to-one communication with each of the processing elements performed by a control unit (CU) that determines the path. Such processing is disclosed, for example, in Japanese Patent Application Laid-Open No. 6-162228.

### SUMMARY OF THE INVENTION

A distributed processing system according to the present invention includes a plurality of processing elements each having one or more inputs and one or more outputs, and a control unit to which the plurality of processing elements are connected, wherein based on a service execution request from a client, the control unit creates execution transition information in which the processing elements that are necessary to execute a specific service and an order of execution are specified.

### BRIEF DESCRIPTION OF THE DRAWINGS

FIG. 1 is a sequence diagram showing a flow of path construction;

FIG. 2 is a diagram showing tasks and paths used in a service;

FIG. 3 is a sequence diagram showing a procedure of path construction according to a first embodiment;

FIG. 4 is a diagram showing assignment of indices to tasks according to the first embodiment;

FIG. 5 is a diagram showing a data structure of a service execution request sent from a client CL to a control unit CU according to the first embodiment;

FIG. 6 is a diagram showing path information sent from the control unit CU to a processing element PE according to the first embodiment;

FIG. 7 shows information sent from one processing element PE to another processing element PE according to the first embodiment;

FIG. 8 shows information sent from the processing elements PE to the control unit CU according to the first embodiment;

FIG. 9 shows the content of a response sent from the control unit CU to the client CL according to the first embodiment.

FIG. 10 is a flow chart of a procedure in the client CL according to the first embodiment.

FIG. 11 is a flowchart of a procedure in the control unit CU according to the first embodiment.

FIG. 12 is a flow chart of a procedure in the processing element PE according to the first embodiment.

FIG. 13 is a diagram showing a sequence of path construction in the case where the path information is sent to the processing elements PE in order from the preceding (or anterior) processing elements PE to the succeeding (or posterior) processing elements PE in the order of execution according to the second embodiment.

FIG. 14 is a diagram showing a sequence of path construction in the case where the path information is broadcast to the processing elements PE according to the third embodiment.

FIG. 15 is a diagram showing the data structure of the path information broadcast from the control unit CU to the processing elements PE according to the third embodiment.

FIG. 16 is a diagram showing a sequence of path construction in the case where the control unit CU sends path information to the processing elements PE by a bucket brigade method in order from the preceding processing elements PE to the succeeding processing elements PE in the order of execution according to the fourth embodiment.

FIG. 17 shows a data structure of the path information sent by the bucket-brigade method according to the fourth embodiment.

FIG. 18 is a diagram showing the content of the path information sent from the control unit CU to the processing element PE1 according to the fourth embodiment.

FIG. 19 is a diagram showing the content of the path information sent from the processing element PE1 to the processing element PE2 according to the fourth embodiment.

FIG. 20 is a diagram showing the content of the path information sent from the processing element PE2 to the processing element PE5 according to the fourth embodiment.

FIG. 21 is a flow chart of a process performed by the control unit CU in accordance with the bucket brigade method according to the fourth embodiment.

FIG. 22 is a flow chart of a process performed in each processing element PE in accordance with the bucket brigade method according to the fourth embodiment.

FIG. 23 is a sequence diagram showing a procedure of transferring the path information by the bucket brigade method in order from the last processing element to the first processing element in the order of execution according to the fifth embodiment

### DETAILED DESCRIPTION OF THE INVENTION

In the following, embodiments of the distributed processing system according to the present invention will be described in detail with reference to the drawings. It should be understood that the present invention is not limited to the embodiments.

Before the description of the embodiments, terms used in the description will be defined.

### (Client)

The term “client CL” refers to a terminal device used by a user. The user can sends instructions to a control unit and processing elements through the client.

(Control Unit)

The term “control unit CU” refers to a control section that performs management of information on the processing elements, makes a determination as to which processing element is to be used in response to a service execution request from a user, performs management of processing paths, and performs management of the transition of execution of tasks during the execution of the service.

(Processing Element)

The term “processing element PE” refers to a node used in computation. The processing element provides a specific process or a task. The processing element has the function of processing or executing one or more tasks, the function of inputting/outputting data needed in the processing, and the function of storing data.

(Data Flow Type Distributed Processing)

For example, a JPEG encoding process may be divided into a plurality of processing blocks such as a downsampling block, a DCT block, and a Huffman encoding block. Thus, the JPEG encoding process may be performed by preparing programs (which may be hardware alternatively) for that implement the respective processing blocks instead of implementing the JPEG encoding process only by a single program. Data input to a certain processing block is processed by the block, and the processed data is output from the block. The output data is then input to the next processing block. In this way, the process proceeds by transferring data from one processing block to another, whereby a larger scale process can be achieved in the entire process. Such a processing framework is called a “data flow type distributed processing”. The data may be transferred through buses or the like of hardware or a network.

(Task)

The term “task” refers to a specific process provided by a processing element. For example, in the case of JPEG encoding process, “downsampling” is a task. Each task is provided with an identification number called a task identifier (TID). The widely used tasks are provided beforehand with task identifiers. It is assumed that the widely used task identifiers are known. A task is executed in a processing elements.

(Service)

The term “service” refers to a set of one or more related tasks. The service provides a process having a more organized purpose than the task. The JPEG encoding is an example of the service.

(Service Number)

The term “service number” refers to a unique number used to identify the service requested by the client CL. The control unit generates service numbers uniquely for respective services and manages them.

(Service Execution Request)

The term “service execution request” refers to a process that a client makes a request for a preparation for the service to be executed to the control unit.

(Path Information)

In the data flow type distributed processing, in order to generate a significant result, it is necessary to interconnect appropriately the processing elements that execute the tasks. The term “path information” refers to an arrangement of the processing elements in this sense. The term “path construction” refers to a process of creating a path. The path information is determined by the control unit.

(Processing Path Allocation)

The term “processing path allocation” refers to a process of enabling mutual communication of data relating to a task processing etc. between processing elements.

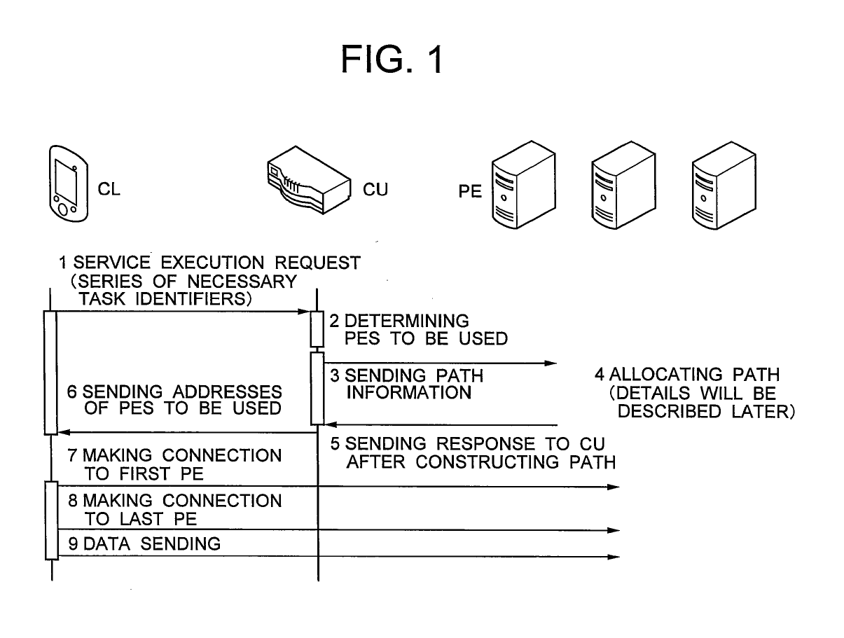

In the following, a procedure of path construction will be described with reference to FIG. 1.

(1) The client CL sends a service execution request to the control unit CU with the designation of tasks necessary for the process and the order of execution of the tasks. Each task is identified by a numerical value called “task identifier” (TID).

(2) The information, such as the address and the task identifier, of the processing elements PE has been registered in the control unit CU in advance. The control unit CU determines the processing elements PE to be used based on the information sent from the client CL.

(3) The control unit CU sends the path information to the processing elements PE.

(4) The paths between the processing elements PE are allocated. Details of the path allocation will be described later.

(5) When the path construction is completed, a response is sent to the control unit CU.

(6) The control unit CU sends the addresses of the processing elements PE to be used to the client CL. The addresses to be sent are the addresses of the first and the last processing elements PE among the processing elements PE that execute the tasks.

(7) The client CL makes a connection to the first processing element PE.

(8) The client CL makes a connection to the last processing element PE.

(9) The client CL sends data to be processed by the service.

The paths other than those leading to the client CL have already been allocated or established. Therefore, the loop of the processing path is completed by establishing connection between the client CL and the first processing element PE, and the connection between the client CL and the last processing element PE.

Connection between the client CL and the last processing element PE is made from the client CL side. The direction of this connection is reverse to the normal direction of connection (from the first processing element toward the last processing element). The reason why the connection is made in the reverse direction is that the client CL normally has a firewall, which will not allow connections from the outside.

### First Embodiment

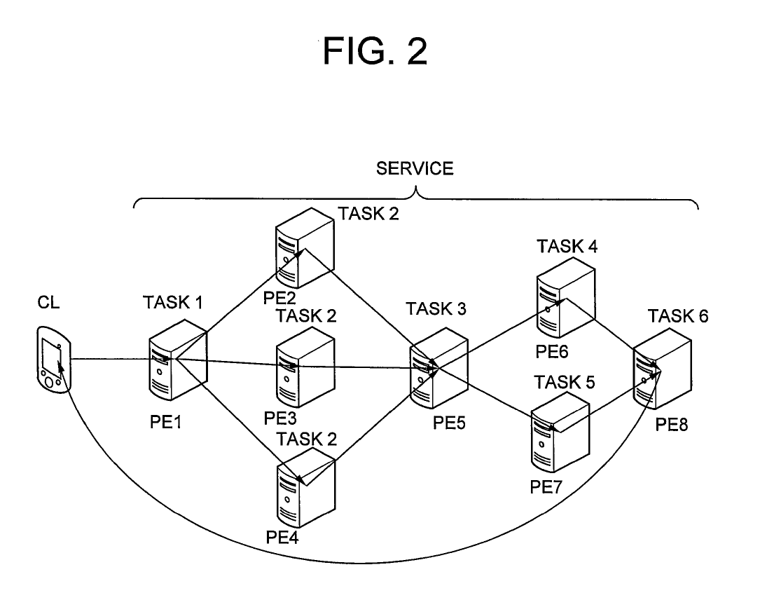

In the following, the distributed processing system according to the first embodiment of the invention will be described taking into account the above described procedure. Here, it is assumed that the client attempts to interconnect tasks in the manner shown in FIG. 2. It should be understood that the interconnections of the processing elements PE are not limited to the following example.

In the embodiment that will be described first, the control unit CU constructs a path by sending, to each of the processing elements PE, the information on the destination and the source of connections with it.

It is assumed that the requirements for the processing elements PE are as follows. The TCP/IP is used for communication. However, the communication protocol is not limited to the TCP/IP. One processing element PE provides one task.

Information on the processing elements PE is presented in Table 1.

TABLE 1

| PE | provided task | PE address |
|---|---|---|
| PE 1 | task 1 | 192.168.0.101 |
| PE 2 | task 2 | 192.168.0.102 |
| PE 3 | task 2 | 192.168.0.103 |
| PE 4 | task 2 | 192.168.0.104 |
| PE 5 | task 3 | 192.168.0.105 |
| PE 6 | task 4 | 192.168.0.106 |
| PE 7 | task 5 | 192.168.0.107 |
| PE 8 | task 6 | 192.168.0.108 |

The definition of the tasks and the task identifiers are presented in Table 2.

TABLE 2

| provided task | task identifier |
|---|---|
| task 1 | 11 |
| task 2 | 12 |
| task 3 | 13 |
| task 4 | 14 |
| task 5 | 15 |
| task 6 | 16 |

The address of the client is presented in Table 3.

TABLE 3
client address
192.168.0.10

The service number used for the service is presented in Table 4.

TABLE 4
service number
199

Information on the processing elements PE has been registered in the control unit CU. It is assumed that the information has already been known. Furthermore, it is assumed that the addresses of the client CL, the processing elements PE, and the control unit CU have already been known.

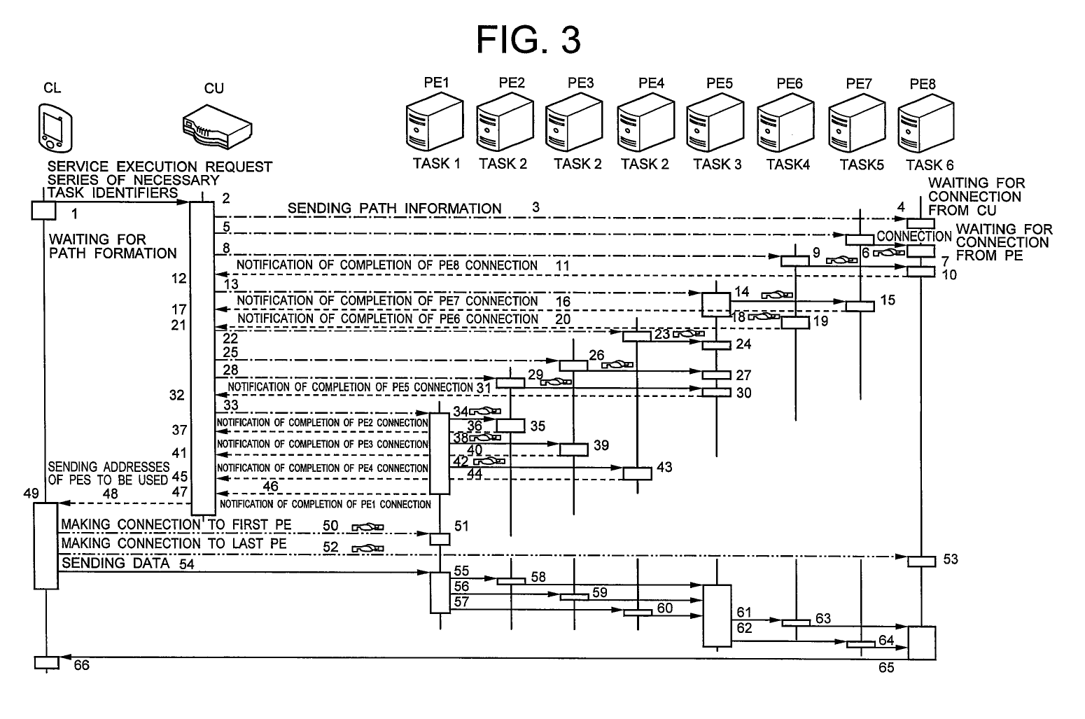

FIG. 3 is a sequence diagram showing a procedure of path construction. In the drawings referred to in the following, connections between the processing elements PE that have been established are indicated by “handshake” icons.

(1) The client CL sends necessary task identifier as a service execution request to the control unit CU. When the path is constructed or an error occurs in the path construction process, the control unit CU will send a response to the client CL. Therefore, the client CL stays standby until it receives the response.

(2) The control unit CU receives the service execution request from the client CL. The control unit CU determines the processing elements PE that provide the tasks constituting the service and creates path information that will be sent to each of the processing elements PE. The control unit CU also creates an identifier, that is, “service number” for identifying the process requested by the client CL.

(3) The control unit CU sends the path information to the processing elements PE sequentially in order from the last processing element PE in the order reverse to the order of execution (as indicated by dashed-dotted lines in FIG. 3). The reason why the control unit CU sends the path information in order from the last processing element PE to the first processing element PE in the execution order is to enable each processing element PE to accept connection(s) made from the preceding processing element(s) PE.

In the path information, there is written the service identifier, the address of the processing element(s) PE to which a connection is made, the address of the processing element(s) PE from which a connection is made, information indicating that the processing element PE that receives the path information is the last or the first processing element, and the address of the client CL.

Once the path information is received by the processing elements PE, the connections between the control unit CU and the processing elements PE are cut off.

(4) The processing elements PE are continuously in a standby state. The processing element PE8 receives the path information from the control unit CU. Being the last processing element PE in the order of execution, the processing element PE8 has no subsequent connection destination. After receiving the path information, the processing element PE8 waits for connections made from the processing elements PE6 and PE7. The processing element PE8 stores the received path information because it will be used later.

(5) The control unit CU sends the path information to the processing element PE7.

(6) After receiving the path information from the control unit CU, the processing element PE7 makes a connection to the next processing element PE or the processing element PE8 (as indicated by solid line in FIG. 3). When making the connection, the processing element PE7 sends information including the service number. The processing element PE8 to which the connection has been made from the processing element PE7 can identify with which service execution request the path information is associated, with reference to the service number. In this way, the path between the processing element PE7 and the processing element PE8 is allocated. Then, the processing element PE7 enters a standby state waiting for a connection made from the preceding processing element PE.

(7) After receiving the connection from the processing element PE7, the processing element PE8 checks whether or not the connection is a legitimate connection, with reference to the service number and the address of the source of the connection. The connection between the processing element PE8 and the processing element PE7 is maintained. Since a connection to the processing element PE8 will also be made from the processing element PE6, the processing element PE8 waits for the connection.

(8) The control unit CU sends the path information to the processing element PE6.

(9) The processing element PE6 receives the path information from the control unit CU and makes a connection to the processing element PE8. Then, the processing element PE6 waits for the connection made from the processing element PE5.

(10) The processing element PE8 accepts the connection made from the processing element PE6.

(11) Since the inputs to the processing element PE8 have all been completed, the processing element PE8 notifies the control unit CU of the completion of connection (as indicated by broken line in FIG. 3).

(12) The control unit CU records the reception of the notification of completion of connection from the processing element PE8 with respect to the corresponding service number. After receiving the notification of completion of connection from all the processing elements PE, the control unit CU notifies the client of that. Therefore, it is necessary for the control unit CU to memorize from which processing elements PE it has received a notification of completion of connection.

(13) The control unit CU sends the path information to the processing element PE5.

(14) The processing element PE5 receives the path information from the control unit CU and makes a connection to the output destination processing element PE, that is, the processing element PE7.

(15) The processing element PE7 accepts the connection made from the processing element PE5.

(16) The processing element PE7 sends a notification of completion of connection to the control unit CU.

(17) The control unit CU receives the notification of completion of connection from the processing element PE7 of the corresponding task and records the reception of the notification.

(18) After making the connection to the processing element PE7, the processing element PE5 makes a connection to the processing element PE6. Then, the processing element PE5 waits for connections made from the processing elements PE2, PE3, and PE4.

(19) The processing element PE6 accepts the connection made from the processing element PE5.

(20) The processing element PE6 sends a notification of completion of connection to the control unit CU.

(21) The control unit CU receives the notification of completion of connection from the processing element PE6 of the corresponding task and records the reception of the notification.

(22) The control unit CU sends the path information to the processing element PE4.

(23) The processing element PE4 receives the path information from the control unit CU and makes a connection to the output destination processing element PE, that is, the processing element PE5.

(24) The processing element PE5 accepts the connection made from the processing element PE4.

(25) The control unit CU sends the path information to the processing element PE3.

(26) The processing element PE3 receives the path information from the control unit CU and makes a connection to the output destination processing element PE, that is, the processing element PE5.

(27) The processing element PE5 accepts the connection made from the processing element PE3.

(28) The control unit CU sends the path information to the processing element PE2.

(29) The processing element PE2 receives the path information from the control unit CU and makes a connection to the output destination processing element PE, that is, the processing element PE5.

(30) The processing element PE5 accepts the connection made from the processing element PE2.

(31) The processing element PE5 sends a notification of completion of connection to the control unit CU.

(32) The control unit CU receives the notification of completion of connection from the processing element PE5 of the corresponding task and records the reception of the notification.

(33) The control unit CU sends the path information to the processing element PE1.

(34) The processing element PE1 receives the path information from the control unit CU and makes a connection to the output destination processing element PE, that is, the processing element PE2.

(35) The processing element PE2 accepts the connection made from the processing element PE1.

(36) The processing element PE2 sends a notification of completion of connection to the control unit CU.

(37) The control unit CU receives the notification of completion of connection from the processing element PE2 of the corresponding task and records the reception of the notification.

(38) The processing element PE1 makes a connection to the output destination processing element PE, that is, the processing element PE3.

(39) The processing element PE3 accepts the connection made from the processing element PE1.

(40) The processing element PE3 sends a notification of completion of connection to the control unit CU.

(41) The control unit CU receives the notification of completion of connection from the processing element PE3 of the corresponding task and records the reception of the notification.

(42) The processing element PE1 makes a connection to the output destination processing element PE, that is, the processing element PE4.

(43) The processing element PE4 accepts the connection made from the processing element PE1.

(44) The processing element PE4 sends a notification of completion of connection to the control unit CU.

(45) The control unit CU receives the notification of completion of connection from the processing element PE4 of the corresponding task and records the reception of the notification.

(46) The processing element PE1 sends a notification of completion of connection to the control unit CU. At this time, the paths between the processing elements PE have been constructed.

(47) The control unit CU receives the notification of completion of connection from the processing element PE1 of the corresponding task and records the reception of the notification.

(48) Since the control unit CU has been received the notifications of completion of connection from all the processing elements PE, the control unit CU sends the result, i.e. the connection information to the client CL (as indicated by broken line in FIG. 3)

(49) The client CL receives the result, i.e. the connection information, namely the PE addresses of the first and the last processing elements PE.

(50) The client CL makes a connection to the first processing element PE (as indicated by dashed-dotted line in FIG. 3).

(51) The processing element PE1 accepts the connection made from the client CL.

(52) The client CL makes a connection to the last processing element PE (as indicated by dashed-two dotted line in FIG. 3).

(53) The processing element PE8 accepts the connection made from the client CL.

(54) The client CL sends the data to be processed to the first processing element PE.

(55) The processing element PE1 processes the data and sends the result to the processing element PE2.

(56) The processing element PE1 sends the result to the processing element PE3.

(57) The processing element PE1 sends the result to the processing element PE4. When sending the result to the three processing elements PE, the processing element PE1 may transmit the result either sequentially to each of the three processing element (one by one) or by broadcast. Whether the same content is sent to all the three processing elements PE or different contents are sent to the respective processing elements PE depends on the application.

(58) The processing element PE2 processes the data and sends the result to the processing element PE5.

(59) The processing element PE3 processes the data and sends the result to the processing element PE5.

(60) The processing element PE4 processes the data and sends the result to the processing element PE5.

(61) After receiving the data from the preceding three processing elements PE, the processing element PE5 processes the data and sends the result to the processing element PE6.

(62) The processing element PE 5 sends the result to the processing element PE7.

(63) The processing element PE6 processes the data and sends the result to the processing element PE8.

(64) The processing element PE7 processed the data and sends the result to the processing element PE8.

(65) The processing element PE8 receives the results from the processing elements PE6 and PE7, processes the data, and sends the result to the client CL.

(66) The client CL receives the result.

The order of sending notifications of completion of connection from the processing elements PE to the control unit CU is not limited to the above described order. The order of making connections from preceding processing elements PE to succeeding processing elements PE is not limited to the above described order.

(Data Structure)

In the following, the data structure will be described.

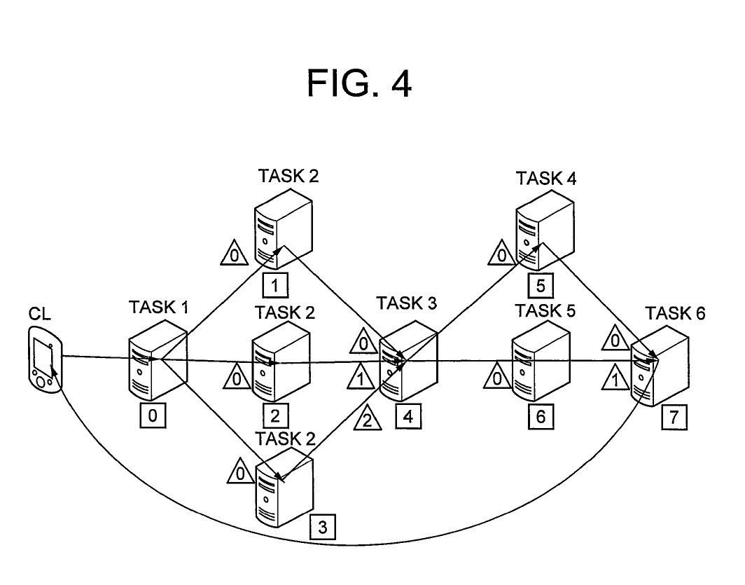

The client CL assigns a unique number (hereinafter, referred to as index arbitrarily) to each of the functions. FIG. 4 is a diagram showing the assignment of the indices to the tasks.

In FIG. 4, numbers in triangles are input pin number, and the numbers in rectangles are indices. This also applies to the other drawings that will be referred to in the following. The input pin number is assigned to an input of the processing element PE, by the client CL. The processing element PE having only one input has only one input pin number of “0”. If the processing element PE has a plurality of inputs, input pin numbers of 1, 2, 3 . . . will follow subsequently. Each input pin has a corresponding preceding processing element PE.

(Communication from Client CL to Control Unit CU, Sequence (1))

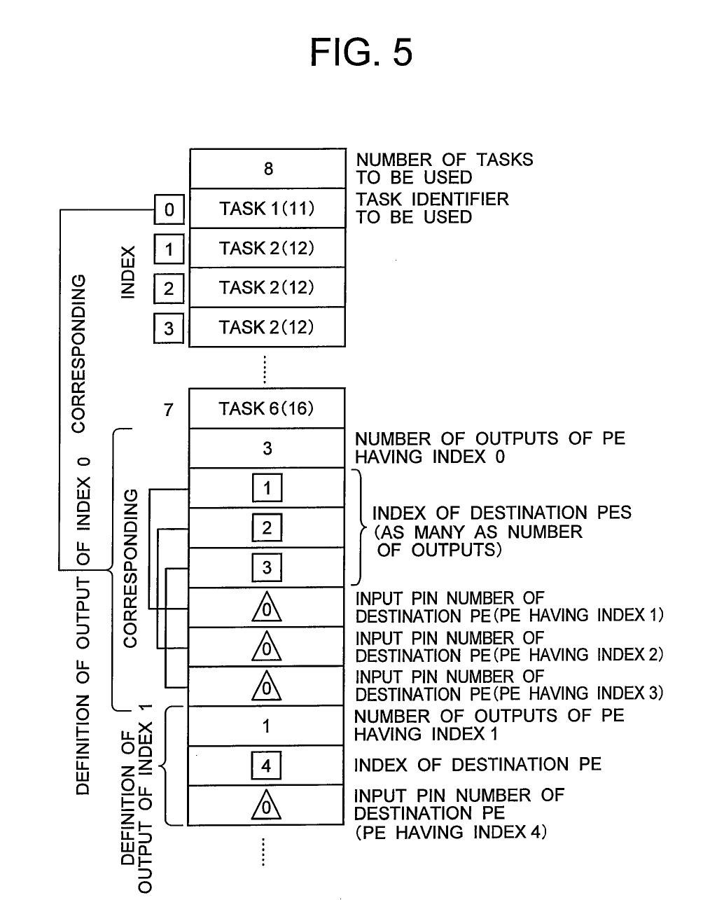

FIG. 5 shows the data structure of a service execution request sent from the client CL to the control unit CU.

First, the number of tasks to be used is written. Subsequently, the task identifiers as many as the number of the tasks to be used are listed. Indices are assigned to the tasks in the order of arrangement of the task identifiers in this data. Subsequently, information on the output and the input of the processing elements PE is written as shown in FIG. 5.

(Communication from Control Unit CU to Processing Element PE, Sequence (3))

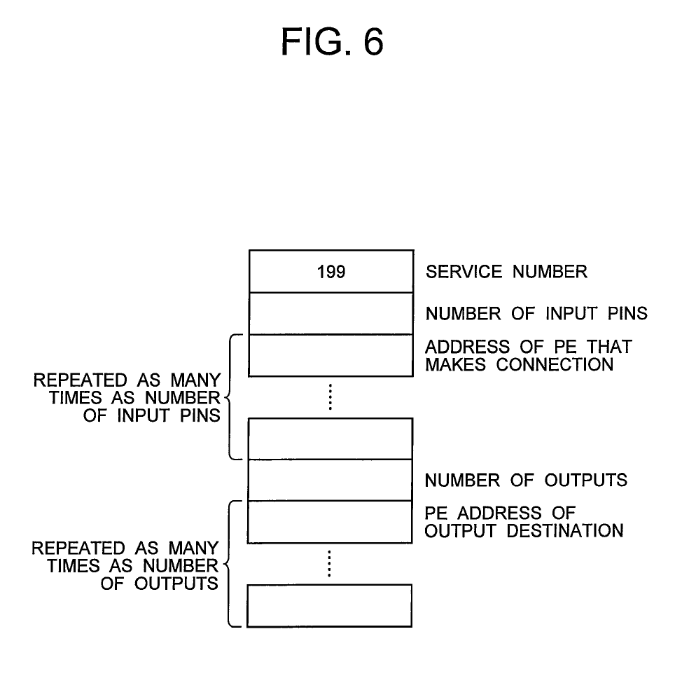

FIG. 6 shows path information sent from the control unit CU to a processing element PE.

The service number is a unique number determined by the control unit CU to identify the request from the client CL. In this case, it is assumed that a service number of “199” is assigned by the control unit CU.

The number of input pins represents the number of other processing elements PE that makes a connection to the processing element PE. From this, the processing element PE can recognize how many connections it should wait for.

There may be cases where another client CL also attempts to use the same processing element PE by chance. In view of this, the processing element needs to be informed of the address(es) of the processing element(s) PE that will make a connection to this processing element PE to make a distinction. Therefore, subsequently to the number of processing elements PE that will make a connection, the address(es) of the processing element(s) PE is written.

The number of outputs is a numeral value that represents the number of the connection destination processing elements PE of the processing element PE. The number of outputs of the last processing element PE (the processing element PE8, in this case) is equal to 0 because it has no succeeding processing element PE. Subsequently to the number of outputs, the addresses of the connection destination processing elements PE are written. Thus, the processing element PE reads the subsequent data to obtain the addresses of the succeeding processing elements PE as many as the number of outputs. Then, the processing element PE makes connections sequentially.

In the case described herein, it is assumed that one processing element executes one task. However, the number of tasks executed by one processing element PE is not limited to one, but one processing element PE may execute multiple tasks. If this is the case, it is necessary to designate the task number of the task to be used at the time when the processing element PE makes a connection to a next processing element PE. In this case, the task number to be used may be added to the above described data structure.

In the following, the communication from one processing element PE to another processing element PE will be described (sequence (6)).

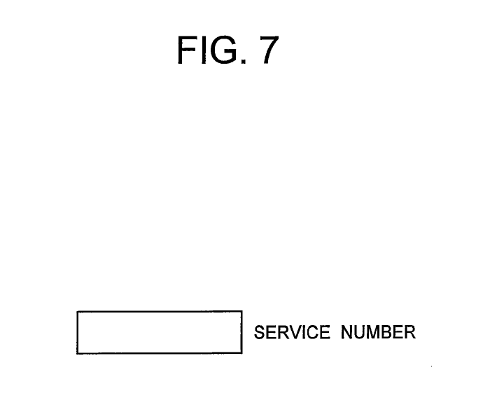

FIG. 7 shows information sent from one processing element PE to another.

The processing element PE to which a connection is made identifies to which task the connection relates, based on the service number. The processing element PE to which the connection has been made (or destination) can know the address of the processing element PE that has made the connection (or source) without receiving the PE address as data. Therefore, the PE address of the source processing element PE is not included in the data. The destination processing element PE can determine whether or not the connection is a legitimate connection based on “the PE address of the source processing element PE” and the service number sent at the time of connection.

The communication from the processing elements PE to the control unit CU will be described (sequence (11)).

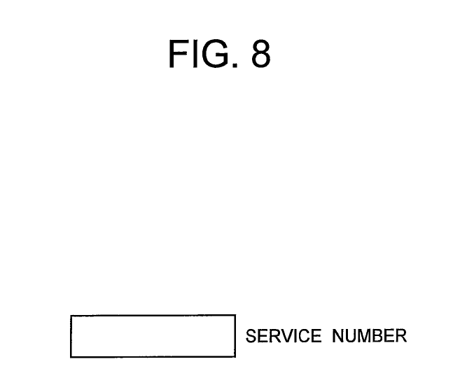

When each processing element PE has established the connections to all the connection destinations and has accepted all the connections made from the designated processing elements PE, it sends a notification of completion of connection to the control unit CU. FIG. 8 shows a data structure sent at this time.

The control unit CU stores the path information it has sent. Then, the control unit CU waits for the arrival of notifications of completion of connection associated with the corresponding service number sent from the processing elements PE.

The communication from the control unit CU to the client CL will be described (sequence (48)).

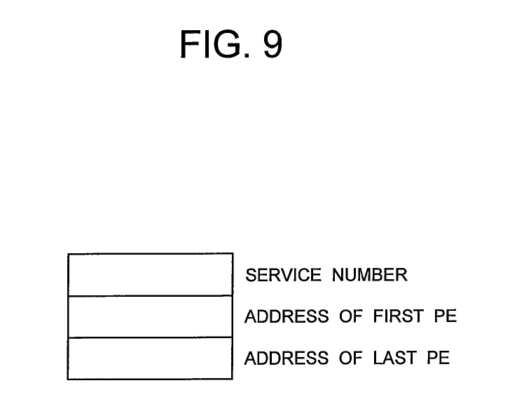

Once receiving responses from all the processing elements PE, the control unit sends the result to the client CL because the paths between the processing elements PE have been allocated. FIG. 9 shows the structure of the data sent at this time. FIG. 9 shows a content of the response sent from the control unit CU to the client CL.

The client CL makes connections to the first and the last processing elements PE with the designated service number, thereby completing the loop of the processing path.

In the following, a flow of the procedure of path construction in the client CL, the control unit CU, and the processing elements PE will be described in order.

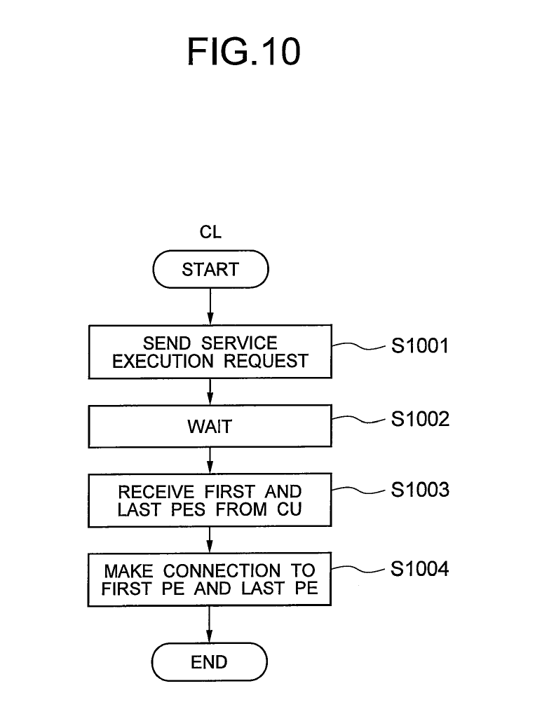

First, the procedure in the client CL will be described with reference to FIG. 10. FIG. 10 is a flow chart of the procedure in the client CL.

In step S1001, the client CL sends a service execution request to the control unit CU.

In step S1002, the client CL stays in standby until it receives a response.

In step S1003, the client CL receives the PE addresses of the first processing element PE and the last processing element PE from the control unit CU.

In step S1004, the client CL makes connections to the first processing element PE and the last processing element PE.

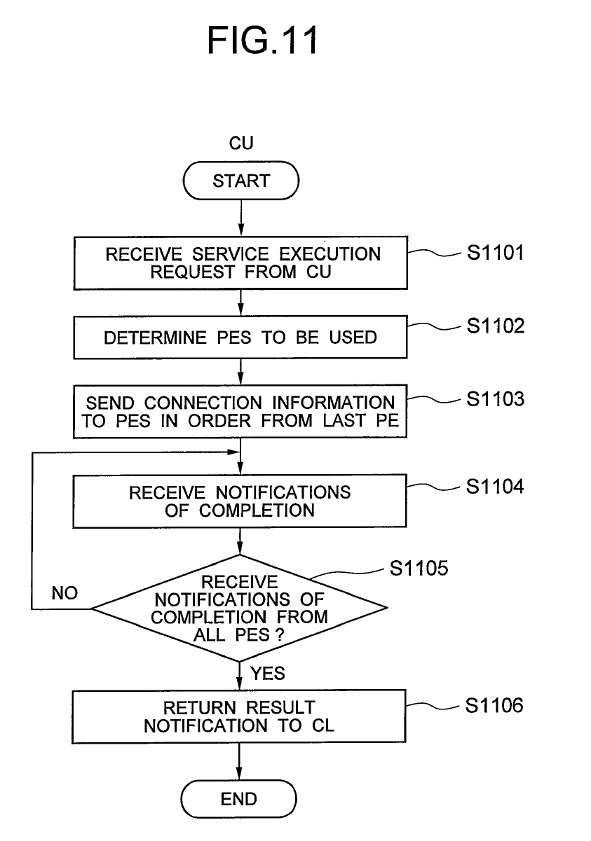

Next, the procedure in the control unit CU will be described with reference to FIG. 11. FIG. 11 is a flow chart of the procedure in the control unit CU.

In step S1101, the control unit CU receives the service execution request from the client CL.

In step S1102, the control unit CU determines the processing elements PE to be used for the service processing.

In step S1103, the control unit CU sends the connection information sequentially in order from the last processing element PE in the direction reverse to the order of execution.

In step S1104, the control unit CU receives notifications of completion of connection from the processing elements PE to which the connection information has been sent.

In step S1105, the control unit CU determines whether or not it has received the notifications of completion of connection from all the processing elements PE.

If the determination in step S1105 is affirmative (Yes), the control unit CU sends, in step S1106, the result to client CL, and the process is terminated. If the determination in step S1105 is negative (No), the process returns to step S1104.

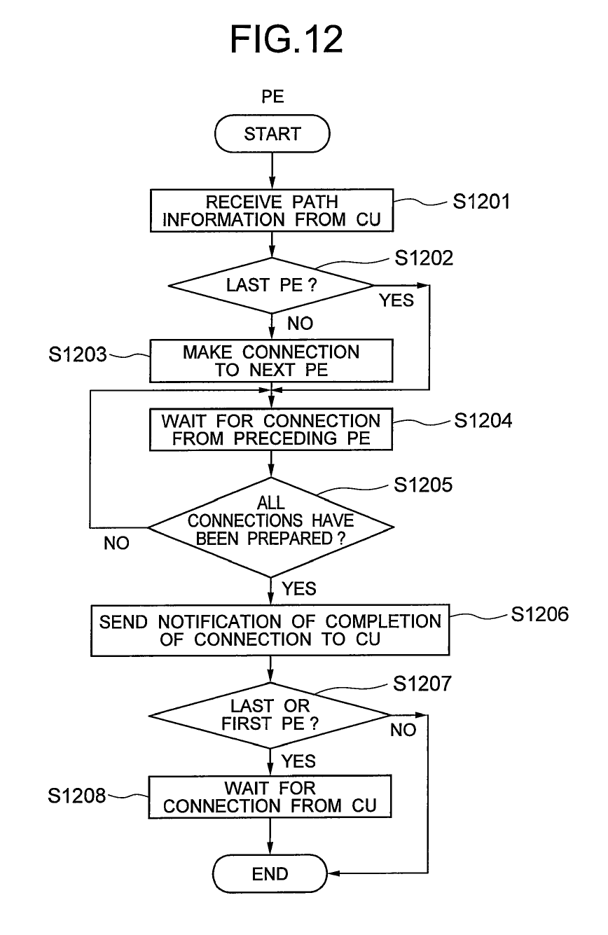

Next, the procedure in the processing element PE will be described with reference to FIG. 12. FIG. 12 is a flow chart of the procedure in the processing element PE.

In step S1201, the processing element PE receives the path information from the control unit CU.

In step S1202, a determination is made as to whether or not the processing element PE is the last processing element PE in the order of execution.

If the determination in step S1202 is negative, the process proceeds to step S1203. In step S1203, the processing element PE makes a connection to the succeeding processing element PE. Then, the process proceeds to step S1204. If the determination in step S1202 is affirmative, the process proceeds to step S1204.

In step S1204, the processing element PE waits for a connection made from the processing element PE preceeding it.

In step S1205, a determination is made as to whether or not all the connections have been established.

If the determination in step S1205 is negative, the process returns to step S1204.

If the determination in step S1205 is affirmative, the process proceeds to step S1206. In step S1206, the processing element PE sends a notification of completion of connection to the control unit CU.

In step S1207, a determination is made as to whether or not the processing element PE is the first or the last processing element. If the determination in step S1207 is negative, the process is terminated. If the determination in step S1207 is affirmative, the processing element PE waits for, in step S1208, a connection made from the client CL.

### Second Embodiment

In the following, a distributed processing system according to the second embodiment of the invention will be described. In the embodiment described herein, the client CL sends path information to the processing elements PE in order from the anterior processing element PE to the posterior processing element PE in the order of execution.

It is assumed that the service to be provided is the same as the above-described service.

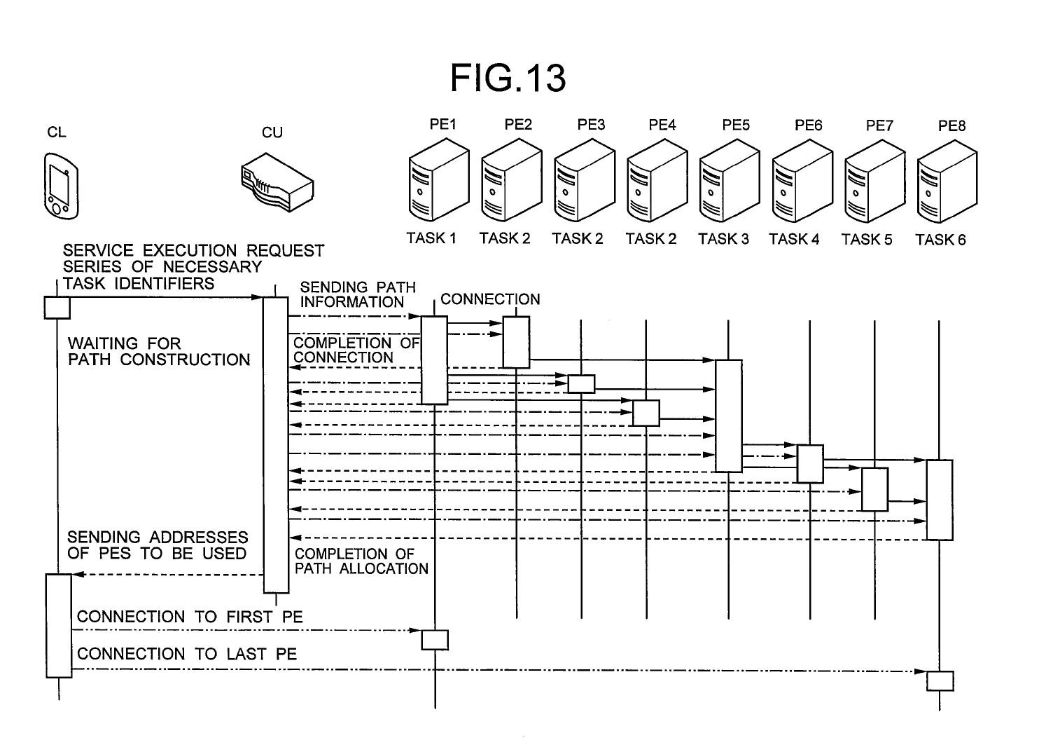

In the case of this embodiment, in the process that the control unit CU sends the path information to the processing elements PE, the control unit CU sends the path information to the processing elements PE sequentially in order from the anterior processing element PE to the posterior processing element PE in the order of execution. FIG. 13 shows this sequence.

FIG. 13 is a diagram showing the sequence of path construction in the case where the path information is sent to the processing elements PE in order from the anterior (first) processing element PE to the posterior (last) processing element PE in the order of execution.

What are represented by the signs used in FIG. 13 are the same as those in the first embodiment. The data structures used in communication, such as path information (dashed-dotted lines), connections (solid lines and broken lines) are the same as those in the first embodiment in which the path information is sent to processing elements PE in order from the posterior processing element PE to the anterior processing element PE in the order of execution.

What is different in this embodiment from the case in which the path information is sent in order from the posterior processing element PE to the anterior processing element PE is that at the time when a processing element PE that has received the path information attempts a connection to a succeeding processing element PE, there is a possibility that the succeeding processing element PE has not received the path information yet.

When a connection is made to the succeeding processing element PE from the preceding processing element PE, the service number is sent to the succeeding processing element PE. Then, the succeeding processing element PE holds the service number in anticipation that the path information associated with service number will be sent from the control unit CU.

If, thereafter, the path information is sent from the control unit CU and the service number in the path information is identical to the service number held in the processing element PE, the processing element PE makes a connection to the next processing element PE. When all the input and outputs connections have been established, the processing element PE sends a notification of completion of connection to the control unit CU.

### Third Embodiment

In the following, a distributed processing system according to the third embodiment of the invention will be described. In the embodiment described here, the path information is broadcasted by the control unit to all the processing elements PE.

It is assumed that the service to be provided is the same as the above-described service.

In the case described here, the path is constructed after the path information is broadcast by the control unit CU to all the processing elements PE that are used in the service.

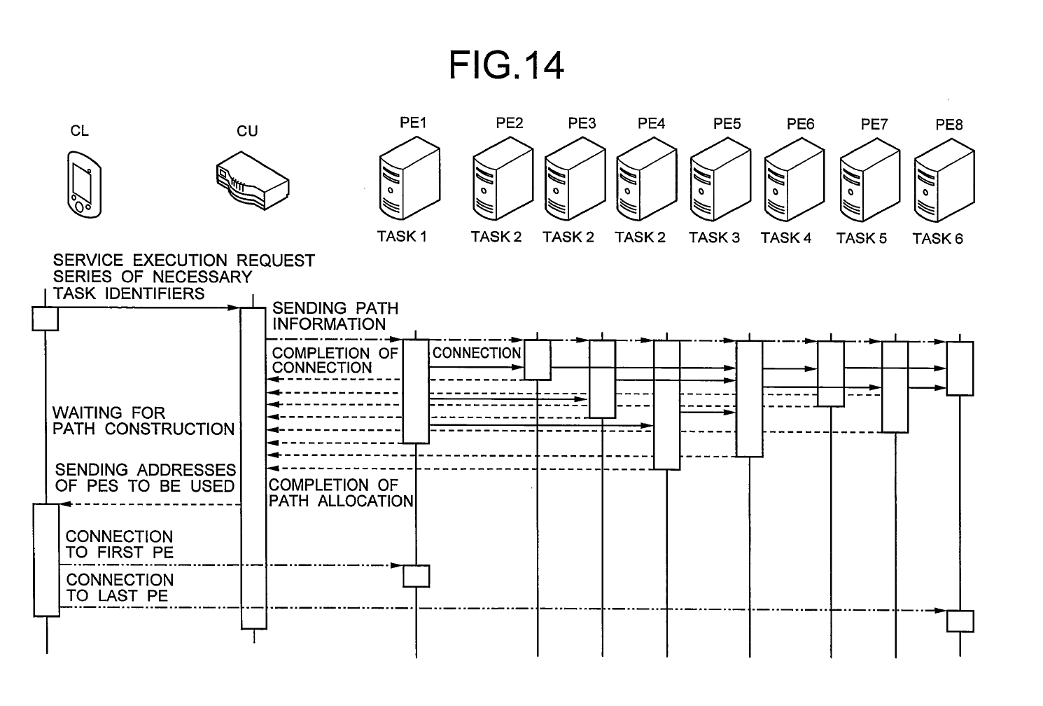

FIG. 14 shows a sequence of path construction in the case where the path information is broadcast to the processing elements PE.

The control unit CU broadcasts the path information to all the processing elements PE that constitute the path.

Each processing element PE that has received the path information makes a connection(s) to the output destination(s) and also accepts a connection(s) made from the input source processing element(s) PE.

Each processing element PE sends a notification of completion of the connection to the control unit CU after all the input and output connections thereof have been established.

(Data Structure)

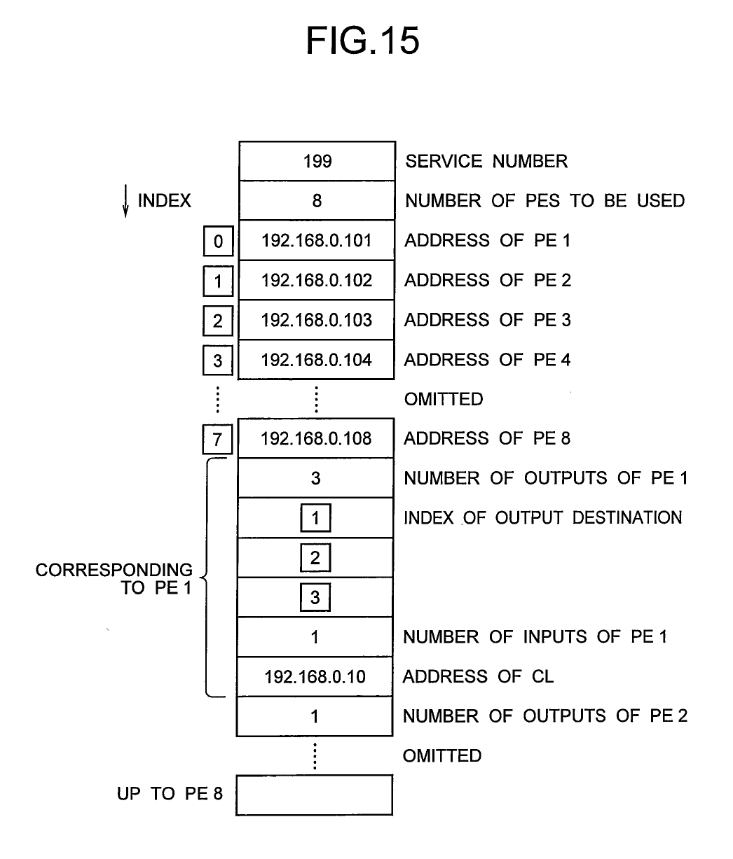

FIG. 15 shows the data structure of the path information broadcast from the control unit CU to the processing elements PE.

Since the path information is broadcast, the data transmitted by a single broadcast has a structure that contains the path information for all the processing elements PE.

The number of the processing elements PE used in the service is written in the field of “number of PEs to be used”. Immediately after this follow the addresses of the processing elements PE as many as the “number of PEs to be used” arranged in the indexed order.

Each of the processing elements PE compares its own IP address with the IP address written in the path information. Thus, it can know its own index.

Subsequently to the PE addresses of the processing elements PE, the number of outputs of the processing element PE, the indices of the output destinations (as many as the number of outputs of the processing element PE), the number of inputs, and the addresses of the input sources (as many as the number of inputs of the processing element PE) are written for the respective processing elements PE in the order of the index number.

Once a processing element PE knows its own index, the processing element PE can read its own input(s) and output(s) written in the information, make a connection(s) to the output destination processing element(s) PE, and wait for a connection(s) made from the input source processing element(s) PE.

### Fourth Embodiment

In the following, the distributed processing system according to the fourth embodiment of the invention will be described. In the embodiment described herein, the path information is transferred from the control unit CU through the processing elements PE by a “bucket brigade” method, in which the path information is transferred sequentially from the preceding processing elements PE to the succeeding processing elements PE in the order of execution.

It is assumed that the service to be provided is the same as the above described service.

In the bucket brigade method, the control unit CU sends all the path information to the first processing element PE. The processing element PE that has received all the path information transfers the path information to the succeeding processing elements) PE. In this way, the path information is transferred to the succeeding processing element(s) PE until the last processing element PE, using the bucket brigade method. The client CL assigns indices to the processing elements PE as is the case with the above-described embodiment. The data structure of the information used in this method will be described later.

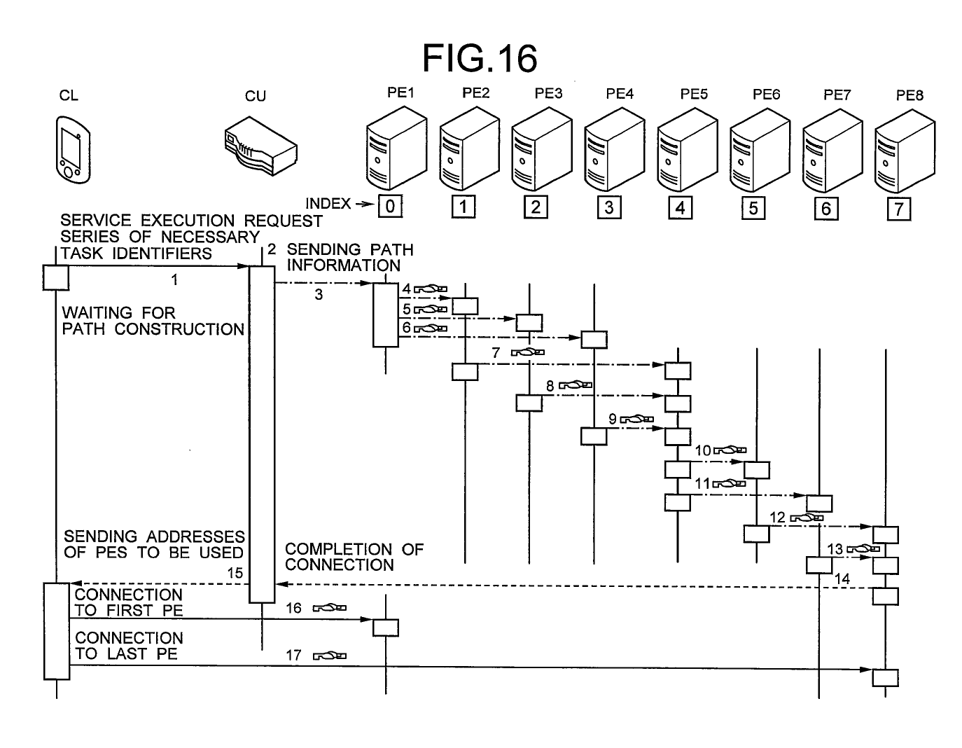

FIG. 16 is a diagram showing the sequence of path construction in the case where the control unit CU sends the path information to the processing elements PE by the bucket brigade method in order from the preceding processing elements PE to the succeeding processing elements PE in the order of execution.

The control unit CU sends the path information to the first processing element PE1. The processing element PE1 makes connections and sends the path information to all the processing elements PE succeeding the processing element PE1, with reference to the path information.

Each processing element PE waits for a connection(s) if there is a processing element(s) PE that will attempt connection to it. For example, in the case of the processing element PE1, the processing element PE that will attempt connection thereto is the client CL. In this way, the path information is transferred from one processing element PE to another. The last processing element PE notifies the control unit CU of the arrival of the path information to the last processing element PE.

A further detail of the procedure will be described with reference to FIG. 16.

(1) The client CL sends a service execution request to the control unit CU (as indicated by solid line in FIG. 16). When the path is constructed or an error occurs in the path construction process, the control unit CU will send a response to the client CL. Therefore, the client CL stays standby until it receives the response.

(2) The control unit CU receives the service execution request from the client CL. The control unit CU determines the processing elements PE that provide the tasks and creates path information to be sent to the processing elements PE.

(3) The control unit CU sends the path information to the first processing element PE1 (as indicated by dashed-dotted line in FIG. 16). Then, the control unit CU waits for the arrival of the notification of completion of connection from the last processing element PE.

(4) The processing element PE1 receives the path information and sends it to the processing element PE2 based on the information written in the path information. The connection between the processing element PE1 and the processing element PE2 is maintained. This means that the path between the processing elements PE1 and PE2 is established at the same time when the processing element PE1 makes a connection to the processing element PE2 to send the path information.

(5) The processing element PE1 also makes a connection to the processing element PE3. Therefore, the processing element PE1 sends the path information also to the processing element PE3.

(6) The processing element PE1 also makes a connection to the processing element PE4. Therefore, the processing element PE1 sends the path information also to the processing element PE4.

(7) The processing element PE2 makes a connection to the output destination processing element PE, that is, the processing element PE5, and sends the path information to it.

(8) The processing element PE3 makes a connection to the output destination processing element PE, that is the processing element PE5, and sends the path information to it.

(9) The processing element PE4 makes a connection to the output destination processing element PE, that is the processing element PE5, and sends the path information to it.

(10) Since the processing element PE5 has received all the inputs, it makes a connection to one of the output destination processing elements PE, that is, the processing element PE6, and sends the path information to it.

(11) The processing element PE5 makes a connection to the other output destination processing element PE, that is, the processing element PE7, and sends the path information to it.

(12) The processing element PE6 makes a connection to the output destination processing element PE, that is, the processing element PE8, and sends the path information to it.

(13) The processing element PE7 makes a connection to the output destination processing element PE, that is, the processing element PE8, and sends the path information to it.

(14) Being the last processing element PE, the processing element PE8 sends a notification of completion of path allocation to the control unit CU.

(15) Since the construction of the path has been completed, the control unit CU sends the PE addresses of the first and the last processing elements PE to the client CL.

(16) The client CL makes a connection to the first processing element PE.

(17) The client CL makes a connection to the last processing element PE.

In the following, the data structure will be described.

The data structure of a service execution request sent from the client CL to the control unit CU is the same as that in the first embodiment.

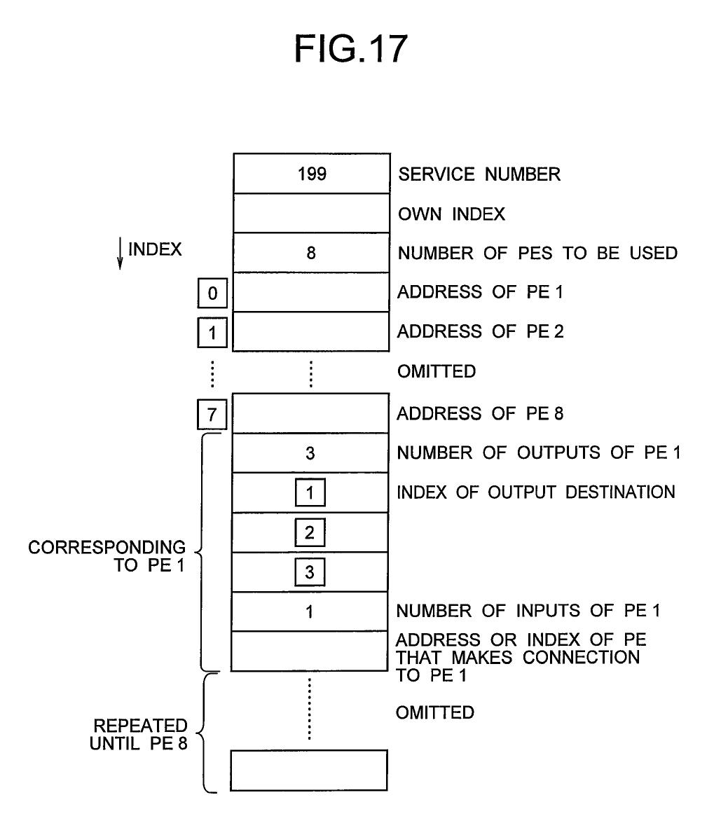

FIG. 17 shows a data structure of the path information sent from the control unit CU to the processing elements PE by the bucket-brigade method. The path information is created by the control unit CU based on the arrangement of the tasks sent from the client CL.

The “own index” in the path information is the index of the processing element PE that receives the path information. Each processing element PE has an index value that is unique to it in the path. In this embodiment, indices are assigned to the processing elements PE as follows.

### PE1 0

### PE2 1

### PE3 2

### PE4 3

### PE5 4

### PE6 5

### PE7 6

### PE8 7

At the time when the path information is sent from the control unit CU to the first processing element PE1, the value of the index is “0”. The processing element PE that sends the path information rewrites the value of the index in conformity with the index of the destination processing element PE to which the path information is sent. The other portions of the path information sent from the control unit CU are not changed and further used without change.

After receiving the path information, the processing element PE refers to the current index. In the path information, the addresses of the processing elements PE are written subsequently to the number of the processing elements PE to be used. With reference to them, each processing element knows the address(es) of the destination processing element(s) PE to which connection(s) is (are) to be made.

Subsequently to the PE addresses of the processing elements PE, the number of outputs of the processing element PE, the indices of the output destination processing elements, and the address(es) of the processing element(s) from which a connection(s) will be made are written for the respective processing elements PE in the order of index number. The processing element PE makes a connection to the output destination processing element PE and sends the path information after rewriting the “current index” into the index of the output destination processing element PE. The processing element performs this process as many times as the number of outputs. Then, the processing element PE waits for a connection(s) from the preceding processing element(s).

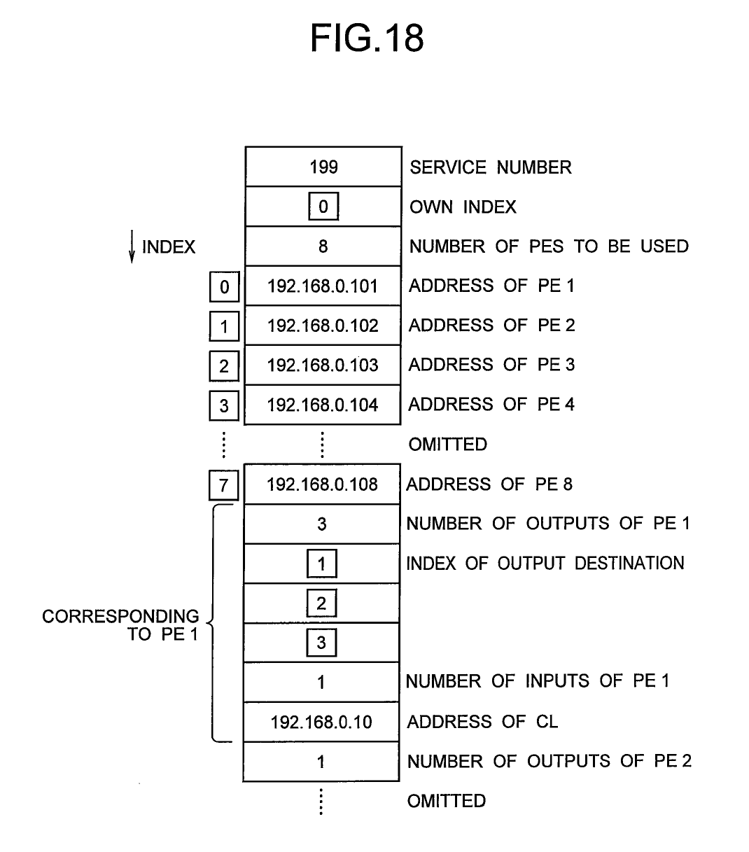

In the following, how the processing element PE1 processes the path information received from the control unit CU will be described with reference to FIG. 18.

FIG. 18 shows the content of the path information sent from the control unit CU to the processing element PE1. This path information is contained in the path information shown in FIG. 17, in other words, FIG. 18 shows the structure of the path information in a more specific manner than FIG. 17.

The processing element PE1 reads its own index from the path information. Since the processing element PE1 is the first processing element PE, the index reads “0”.

The subsequent item in the path information is the number of the processing elements PE to be used. The processing element PE1 skips this item and reads the number of outputs of the processing element PE1. In the case shown in FIG. 18, the number of outputs of the processing element PE1 reads “3”, from which the processing element PE1 can know that connections are to be made to three processing elements.

Subsequently, the indices of the processing elements PE to which the connections are to be made are written. Therefore, the addresses of these processing elements PE can be obtained with reference to the aforementioned correspondence between the indices and the PE addresses.

Thus, the processing element PE1 can make connections to the three output destination processing elements PE. After the connections have been established, the processing element PE1 rewrites the “own index” in the path information received from the control unit CU into the index of each of the output destination processing element PE and sends the path information to each of them.

The processing element PE1 also reads the address of the input source processing element PE written subsequently to the output destinations in the path information. Since the processing element PE1 is the first processing element PE, the processing element PE that will make a connection thereto is the client CL. Therefore, the address written in this field is the address of the client CL. The processing element PE1 waits for a connection with the same service number made from the client CL.

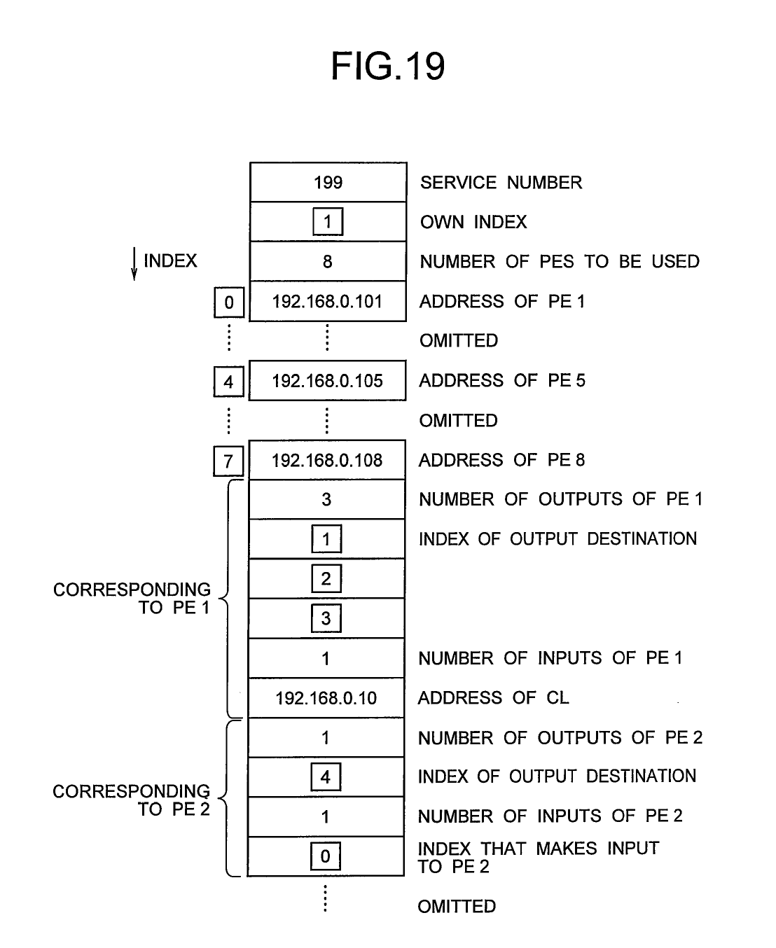

FIG. 19 shows the content of the path information sent from the processing element PE1 to the processing element PE2.

After receiving the path information, the processing element PE2 refers to the “own index” field, and reads the field of the path information concerning the output associated with the index of “1” while skipping the intervening information. Thus, the processing element PE2 knows that the index of the output destination processing element PE is “4”, that is, the processing element PE5. The processing element PE2 makes a connection to the processing element PE5 accordingly.

In doing so, the processing element PE2 changes the “own index” field of the received path information into “4” and sends the path information. The processing element PE2 reads the field of the path information concerning the input to the processing element PE2 to know that a connection will be made to it only from the processing element having an index of “0” (i.e. the processing element PE1). The processing element PE2 waits for the connection with a service number of “199” made from the processing element PE1.

Next, the operation of the processing element PE5 to which a connection is made from the processing element PE2 will be described.

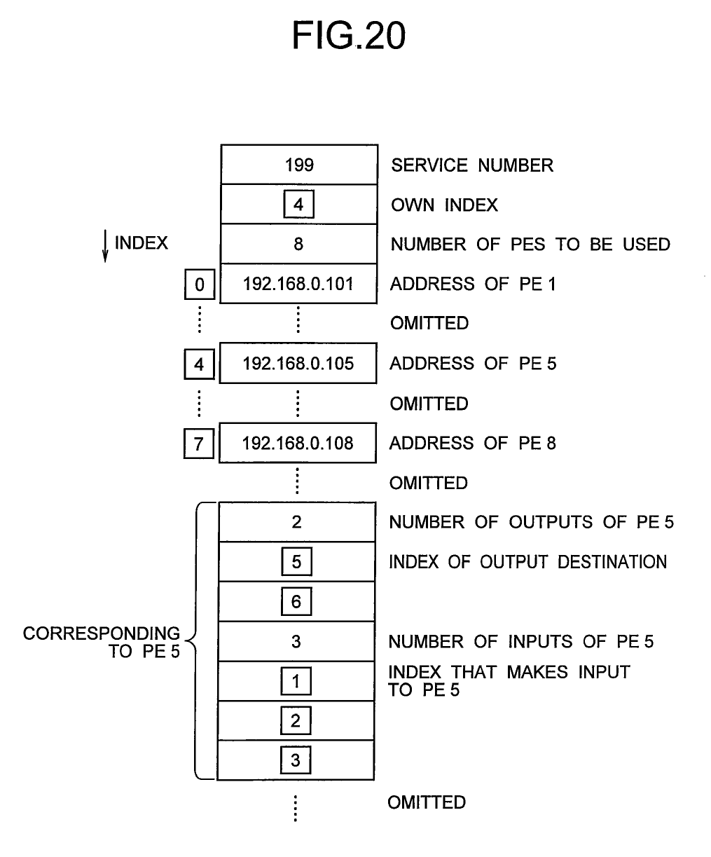

FIG. 20 shows the content of the path information sent from the processing element PE2 to the processing element PE5.

Connections from three processing elements PE will be made to the processing element PE5. It is indeterminate from which processing element PE among the three processing elements PE the first connection is made. After the first reception of the path information, the processing element PE5 can know, from the path information, how many connections will be made by which processing elements. Then, the processing element PE5 can wait for connections made from other processing elements.

Therefore, the connections to the processing element PE5 may be made in any order. Connections from the processing element PE5 to the succeeding processing elements PE are made by the process same as that in the case of the processing elements PE1 and PE2.

The processes performed by the other processing elements PE are the same as those described above, and redundant descriptions will be omitted. After the inputs to the last processing element PE have all been completed, the last processing element PE notifies the control unit that the path information has been delivered to the last processing element.

In the following, the processes of path construction performed respectively by the client CL, the control unit CU, and the processing elements PE in this embodiment will be described. The process performed by the client CL is the same as that in the case where the control unit CU sends the path information directly to the each of the processing elements PE.

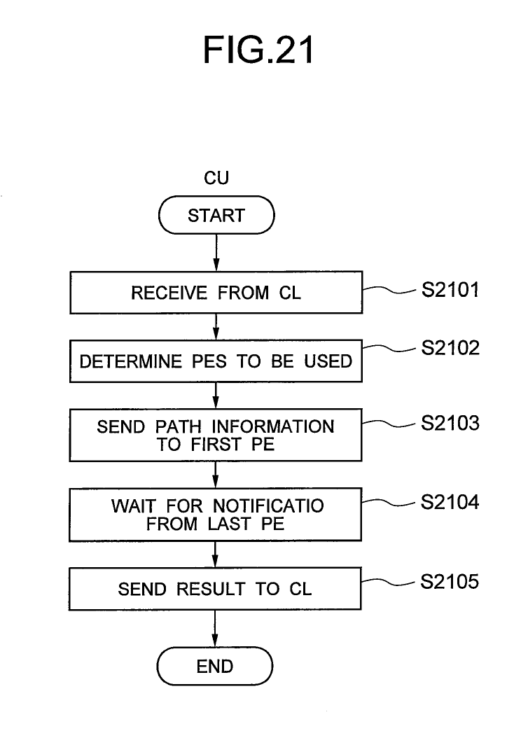

FIG. 21 is a flow chart of the process performed by the control unit CU in accordance with the bucket brigade method.

In step S2101, the control unit CU receives a service execution request from the client CL.

In step S2102, the control unit CU determines the processing elements PE to be used.

In step S2103, the control unit CU sends path information to the first processing element PE in the order of execution.

In step S2104, the control unit CU waits for a notification from the last processing element PE that will be sent after completion of sequential transfer of the path information by the bucket brigade method.

In step S2105, after receiving the notification from the last processing element PE, the control unit CU notifies the client CL of the result.

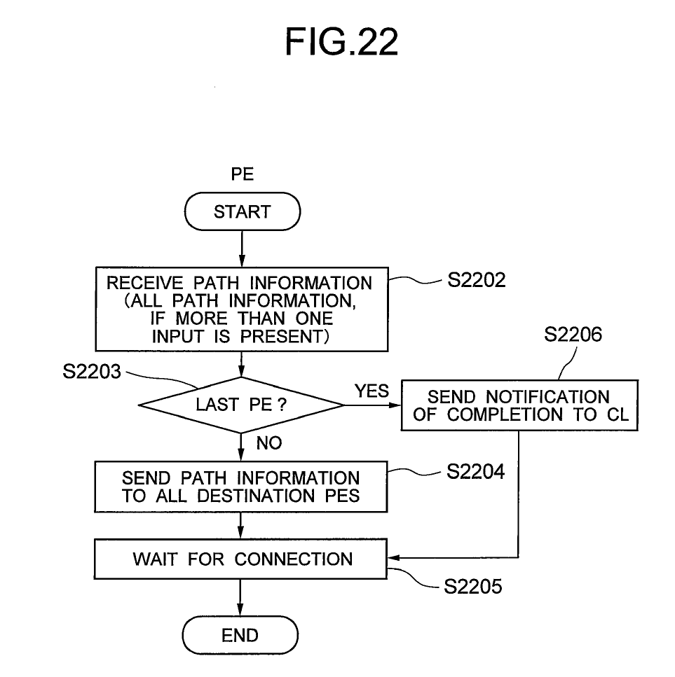

FIG. 22 is a flow chart of the process performed in each processing element PE in accordance with the bucket brigade method.

In step S2202, the processing element PE receives the path information. If there are multiple inputs to the processing element PE, it receives the path information from all the input sources.

In step S2203, a determination is made as to whether or not the processing element PE is the last processing element PE.

If the determination in step S2203 is affirmative, the processing element PE sends a notification of completion to the control unit CU in step S2206, and then proceeds to step S2205.

On the other hand, if the determination in step S2203 is negative, the processing element PE proceeds to step S2204, where it sends the path information to all the output destination processing elements PE.

In step S2205, the processing element PE waits for connections made to it, and terminates the process.

### Fifth Embodiment

In the following, a distributed processing system according to the fifth embodiment of the invention will be described. In the embodiment described herein, the path information is transferred from the control unit CU through the processing elements PE by a bucket brigade method, in which the path information is transferred from the last processing element PE to the first processing element PE in the order of execution.

In this embodiment, the method of transferring the path information sequentially from the posterior processing elements PE to the anterior processing elements PE in the order of execution will be described.

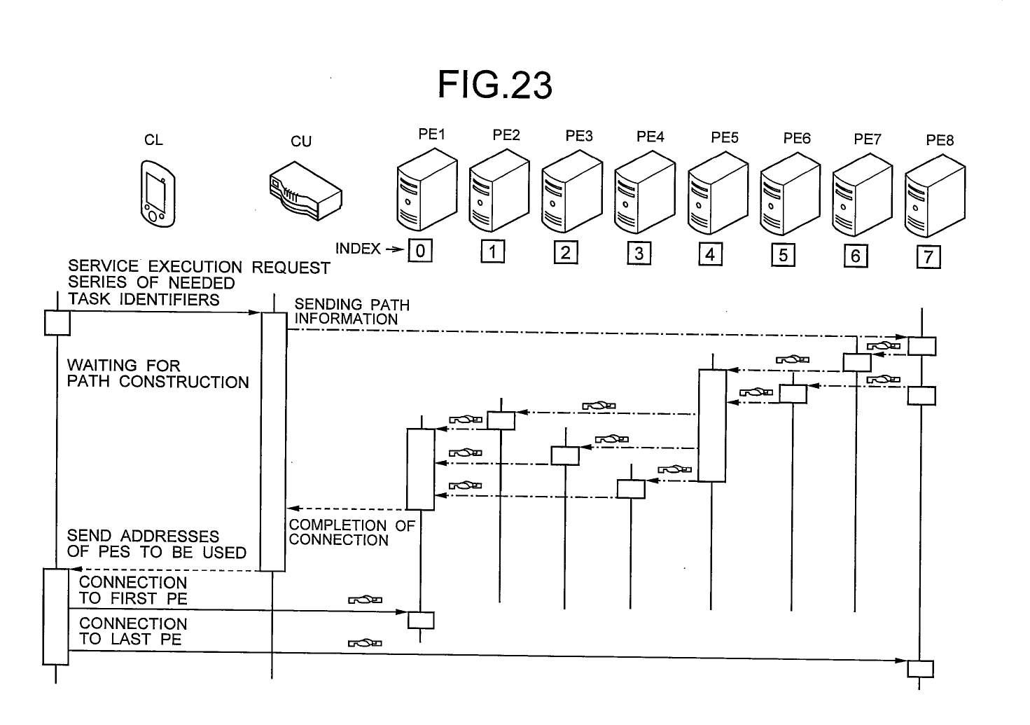

FIG. 23 is a sequence diagram showing the procedure of transferring the path information by the bucket brigade method in order from the last processing element PE to the first processing element PE in the order of execution.

The data structure of the path information used in this embodiment is the same as that in the above-described case in which the path information is sent from the first processing element PE to the last processing element PE in the order of execution.

The control unit CU sends the path information to the last processing element PE8. While in the above-described case in which the path information is transferred in the direction from the first processing element toward the last processing element, the index set in the path information sent from the control unit CU is “0”, in the case where the path information is transferred in the direction from the last processing element toward the first processing element, the value of the index varies depending on the number of processing elements. In this embodiment, the value of the index in the path information sent from the control unit CU is set to “7”.

The processing element PE8 makes connections to its input source processing elements PE6 and PE7. The other processing elements PE also make a connection(s) to their input source processing elements PE while rewriting the index in the path information appropriately. The first processing element PE sends a notification of completion of connection to the control unit CU.

Although TCP/IP communication is used in the above-described embodiments, UDP communication may be used. Any communication scheme, whether wired or wireless, may be used without limitation as long as the above-described communication processes can be implemented.

The timing of sending the notification of completion in the sequence diagrams in the above described embodiments is not limited to those described above.

In the sequence diagrams in the above described embodiments, the processing element PE having a plurality of output destinations may send the path information to the succeeding processing elements PE in order different from those described above.

In the sequence diagrams in the above-described embodiments, the processing element PE having a plurality of input sources may receive the path information from the preceding processing element in order different from those described above.

The data structure of the information is not limited to those described with the embodiments. Any data structure may be used as long as the above-described operations can be achieved.

As described in the foregoing, with the present invention, a processing path, which has conventionally been constructed by sequentially connecting processing elements each having one input and one output, can be branched into multiple paths, and multiple paths can be merged into a single path. Thus, the present invention can increase the degree of freedom of path design and have various applications.

As described above, the present invention can suitably applied to a distributed processing system having a high degree of freedom.

The present invention is advantageous in that it can provide a distributed processing system in which a path can be constructed using processing elements having multiple inputs and/or multiple outputs.

What is claimed is:

1. A distributed processing system comprising:
a plurality of processing elements each having one or more inputs and one or more outputs: and
a control unit to which the plurality of processing elements are connected,
wherein based on a service execution request from a client, the control unit creates execution transition information in which the processing elements that are necessary to execute a specific service and an order of execution are specified.

2. The distributed processing system according to claim 1, wherein after determining a processing path, the control unit sends the same execution transition information to each of the plurality of processing elements that are necessary to execute the specific service.

3. The distributed processing system according to claim 2 wherein the control unit sends the execution transition information to the plurality of processing elements simultaneously.

4. The distributed processing system according to claim 2, wherein the execution transition information is sent to the processing elements sequentially in order from the first processing element in the order of execution to the last processing element in the order of execution.

5. The distributed processing system according to claim 2, wherein the execution transition information is sent to the processing elements sequentially in order from the last processing element in the order of execution to the first processing element in the order of execution.

6. The distributed processing system according to claim 1, wherein after determining a processing path, the control unit sends the execution transition information only to the first processing element in the order of execution among the processing elements that are necessary to execute the specific service.

7. The distributed processing system according to claim 1, wherein after determining a processing path, the control unit sends the execution transition information only to the last processing element in the order of execution among the processing elements that are necessary to execute the specific service.

8. The distributed processing system according to claim 4, wherein after receiving the execution transition information, each of the processing elements sends the execution transition information to another succeeding processing element.

9. The distributed processing system according to claim 2, wherein one of the processing elements has one input and a plurality of outputs and are connected to two or more other processing elements.

10. The distributed processing system according to claim 2, wherein one of the processing elements has a plurality of inputs and one output and are connected to two or more other processing elements.

11. The distributed processing system according to claim 2, wherein one of the processing elements has a plurality of inputs and a plurality of outputs and are connected to two or more other processing elements.
